(19) United States
(12) Patent Application Publication
(10) Pub. No.: US 2010/0002764 A1
(43) Pub. Date: Jan. 7, 2010

(54) Method For Encoding An Extended-Channel Video Data Subset Of A Stereoscopic Video Data Set, And A Stereo Video Encoding Apparatus For Implementing The Same

(75) Inventors: Wen-Nung Lie, Ming-Hsiung Township (TW); Jui-Chiu Chiang, Ming-Hsiung Township (TW); Lien-Ming Liu, Tainan City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: National Cheng Kung University, Tainan City (TW)

(21) Appl. No.: 12/346,505

(22) Filed: Dec. 30, 2008

(30) Foreign Application Priority Data
Jul. 3, 2008 (TW) 097125182

(51) Int. Cl. H04N 7/26; H04N 13/00

(52) U.S. Cl. 375/240.08; 348/42; 375/E07.2

(57) ABSTRACT

A method for generating candidate encoding modes for an extended-channel video data subset of a stereo video data set includes the steps of: generating, for each macroblock of each frame of the extended-channel video data subset, a forward time difference image feature parameter set with reference to pixel values of pixels of the macroblock and a corresponding macroblock of a corresponding preceding frame; generating, for each macroblock, a plurality of first output values that respectively correspond to a plurality of predetermined possible block partition sizes with reference to the forward time difference image feature parameter set; and selecting, for each macroblock, a first number of candidate block partition sizes from the possible block partition sizes based on the first output values The candidate encoding modes include combinations of the first number of candidate block partition sizes and at least a part of a plurality of predetermined possible block estimation directions.

### CROSS-REFERENCE TO RELATED APPLICATION

This application claims priority to Taiwanese Application No. 097125182, filed Jul. 3, 2008, the disclosure of which is incorporated herein by reference.

### BACKGROUND OF THE INVENTION

1. Field of the Invention

The invention relates to a method and apparatus for stereo video encoding, more particularly to a method for encoding an extended-channel video data subset of a stereo video data set by first selecting a group of candidate encoding modes from which an optimum encoding mode is subsequently selected in order to reduce computation time, and a stereo video encoding apparatus for implementing the method.

2. Description of the Related Art

Human's spatial visual perception originates from the observation of an identical scene at two different perspective angles using left and right eyes, similar to capturing an image of an object in three-dimensional space by two cameras that are disposed in parallel to each other. There is a slight displacement between the images captured by the left and right eyes, which is called “disparity”. Upon receipt of the images captured by the left and right eyes, through certain physical and psychological reactions, the human brain perceives the object in three-dimensions. When using a conventional stereoscopic video system, it is mandatory for a viewer to wear a pair of special viewing glasses, such as a pair of red-blue light filtering glasses. This kind of viewing glasses is basically a pair of light filters. A video outputted by a playback device of the conventional stereoscopic video system includes two sets of data respectively encoded in light beams having two different wavelengths. The viewing glasses essentially filter out the respective light beams corresponding to the respective sets of data designated for the left and right eyes, respectively. In recent years, as stereoscopic display technology progresses, companies like Philips and Sharp already have active stereoscopic display devices on the market that permit viewers to watch stereoscopic video with naked eyes.

As stereoscopic display technology advances, there is an increasing demand for stereoscopic video (also known as stereo video) contents. However, the amount of data for stereo video is twice that of conventional monocular video. Hence, when considering transmission and storage of the stereo video, it is especially important to effectively compress the stereo video. In recent years, the most popular video compression standard is H.264/AVC (H.264 for Advanced Video Coding) which is the latest video compression standard developed by the JVT (Joint Video Team) founded cooperatively by ITU-T VCEG (International Telecommunication Unit-Telecommunication Standardization Sector, Video Coding Experts Group) and ISO/IEC MPEG (International Organization for Standardization/International Electrotechnical Commission, Moving Picture Experts Group).

JVT is currently developing a reference software named JMVM (Joint Multi-view Video Model) based on a H.264/AVC-standard-like principle. This JMVM reference software includes compressing and decompressing functionalities for stereo video and joint multi-view video (note that the stereo video can be deemed a special case of the joint multi-view video). For a stereo video data set including two sets of image sequences, namely a left-channel image sequence and a right-channel image sequence, the left-channel images are encoded using the H.264/AVC standard, whereas the right-channel images are coded not only with reference to corresponding preceding and corresponding succeeding images as with the H.264/AVC standard, but also with reference to the left-channel images corresponding thereto in time, so as to reduce redundancy of encoded data. Since stereo video encoding is capable of eliminating redundancy of data in the right-channel images, a better encoding efficiency can be achieved as compared to encoding the left-channel images and the right-channel images separately as monocular video using the H.264/AVC standard.

However, since the right-channel images are encoded with reference to the corresponding left-channel images, which is referred to as “disparity estimation”, encoding mode selection (or mode optimization) for the right-channel images is ever more complicated, resulting in a very long computation time, which is especially true when a H.264/AVC-standard-like principle is used.

A conventional method for increasing compression (encoding) speed of stereo video encoding is disclosed in U.S. Pat. No. 6,430,334, which utilizes a specific relationship between a parallax vector and a motion vector for each macroblock (MB) to reduce a motion vector search area for the macroblocks that are to be encoded in the right-channel. However, for a stereo video encoding technique based on a H.264/AVC-standard-like principle, there are thousands of possible encoding modes for each macroblock, including combinations of numerous block partition sizes, various motion/disparity selections, and combinations of forward/backward motions, etc. In view of this, the mere reduction of the motion vector search area for each of the possible encoding modes is not sufficient to effectively increase the compression speed of stereo video encoding.

Therefore, there is a demand for an encoding mode selection method that helps increase the compression speed of stereo video encoding.

### SUMMARY OF THE INVENTION

Therefore, the main object of the present invention is to provide a method for generating a group of candidate encoding modes for an extended-channel video data subset of a stereo video data set. A second object of the present invention is to provide a method for selecting an optimum encoding mode for the extended-channel video data subset of a stereo video data set. A third object of the present invention is to provide a method for encoding the extended-channel video data subset of the stereo video data set.

According to a first aspect of the present invention, there is provided a method for generating a group of candidate encoding modes, from which an optimum encoding mode is to be selected for subsequent encoding of an extended-channel video data subset of a stereo video data set with reference to a basic-channel video data subset of the stereo video data set. Each of the extended-channel video data subset and the basic-channel video data subset includes a plurality of frames. Each of the frames includes a plurality of macroblocks. Each of the macroblocks includes a plurality of pixels. The method includes the steps of:

(A) generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;

(B) generating, for each of the macroblocks of each of the frames of the extended-channel video data subset, a plurality of first output values that respectively correspond to a plurality of predetermined possible block partition sizes with reference to the forward time is difference image feature parameter set for the corresponding one of the macroblocks of the extended-channel video data subset; and

(C) selecting, for each of the macroblocks of the extended-channel video data subset, a first number of candidate block partition sizes from the possible block partition sizes based on the first output values.

The group of candidate encoding modes for each of the macroblocks of the extended-channel video data subset includes combinations of the first number of candidate block partition sizes for the corresponding one of the macroblocks of the frames of the extended-channel video data subset and at least a part of a plurality of predetermined possible block estimation directions.

According to a second aspect of the present invention, there is provided a method for selecting an optimum encoding mode for subsequent encoding of an extended-channel video data subset of a stereo video data set with reference to a basic-channel video data subset of the stereo video data set. In addition to the steps (A) to (C) as listed above, the method further includes the step of: (D) selecting, for each of the macroblocks of the extended-channel video data subset, the optimum encoding mode from the group of candidate encoding modes.

According to a third aspect of the present invention, there is provided a method for encoding an extended-channel video data subset of a stereo video data set with reference to a basic-channel video data subset of the stereo video data set. In addition to the steps (A) to (D) as listed above, the method further includes the step of: (E) encoding the extended-channel video data subset according to the optimum encoding modes selected for the macroblocks of the frames thereof.

A fourth object of the present invention is to provide a candidate encoding mode generating device unit for generating a group of candidate encoding modes for an extended-channel video data subset of a stereo video data set. A fifth object of the present invention is to provide an encoding mode selecting device for the extended-channel video data subset of the stereo video data set. A sixth object of the present invention is to provide a stereo video encoding apparatus.

According to a fourth aspect of the present invention, there is provided a candidate encoding mode generating device unit for generating a group of candidate encoding modes, from which an optimum encoding mode is to be selected for subsequent encoding of an extended-channel video data subset of a stereo video data set with reference to a basic-channel video data subset of the stereo video data set. Each of the extended-channel video data subset and the basic-channel video data subset includes a plurality of frames. Each of the frames includes a plurality of macroblocks. Each of the macroblocks includes a plurality of pixels. The candidate encoding mode generating unit includes an image feature computing module, a first processing module, and a candidate encoding mode selecting module.

The image feature computing module is adapted for receiving the extended-channel video data subset, and generates, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset.

The first processing module is coupled electrically to the image feature computing module for receiving the forward time difference image feature parameter set therefrom, and generates, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset.

The candidate encoding mode selecting module is coupled electrically to the first processing module for receiving the first output values therefrom, and selects, for each of the macroblocks of the extended-channel video data subset, a first number of candidate block partition sizes from the possible block partition sizes based on the first output values.

The candidate encoding mode selecting module generates, for each of the macroblocks of the extended-channel video data subset, the group of candidate encoding modes that includes combinations of the first number of candidate block partition sizes for the corresponding one of the macroblocks of the extended-channel video data subset and at least a part of a plurality of predetermined possible block estimation directions.

According to a fifth aspect of the present invention, there is provided an encoding mode selecting device for an extended-channel video data subset of a stereo video data set. The encoding mode selecting device includes the candidate encoding mode generating unit as disclosed above, and an optimum encoding mode selecting module. The optimum encoding mode selecting module is coupled electrically to the candidate encoding mode selecting module of the candidate encoding mode generating unit for receiving the group of candidate encoding modes therefrom, and determines, for each of the macroblocks of the extended-channel video data subset, an optimum encoding mode from the group of candidate encoding modes for the corresponding one of the macroblocks of the extended-channel video data subset.

According to a sixth aspect of the present invention, there is provided a stereo video encoding apparatus for encoding a stereo video data set that includes an extended-channel video data subset and a basic-channel video data subset. The stereo video encoding apparatus includes the encoding mode selecting device as disclosed above, and an encoding module. The encoding module is coupled electrically to the optimum encoding mode selecting module of the encoding mode selecting device for receiving the optimum encoding modes therefrom, is adapted for encoding the basic-channel video data subset so as to generate a basic-channel bit stream from the basic-channel video data subset, and is further adapted for generating an extended-channel bit stream from the extended-channel video data subset according to the optimum encoding modes received from the optimum encoding mode selecting module.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a stereo video encoding apparatus according to the preferred embodiment of the present invention;

FIG. 2 is a block diagram of an encoding mode selecting device of the stereo video encoding apparatus according to the preferred embodiment of the present invention;

FIG. 3 is a flowchart of a method for generating a group of candidate encoding modes according to the preferred embodiment of the present invention;

FIG. 4 is a schematic diagram, illustrating possible prediction sources in a forward direction, a backward direction and a disparity direction used in the method for generating a group of candidate encoding modes according to the present invention; and

FIG. 5 is a schematic diagram, illustrating a plurality of predetermined possible block partition sizes used in the method for generating a group of candidate encoding modes according to the present invention.

### DETAILED DESCRIPTION OF THE PREFERRED EMBODIMENT

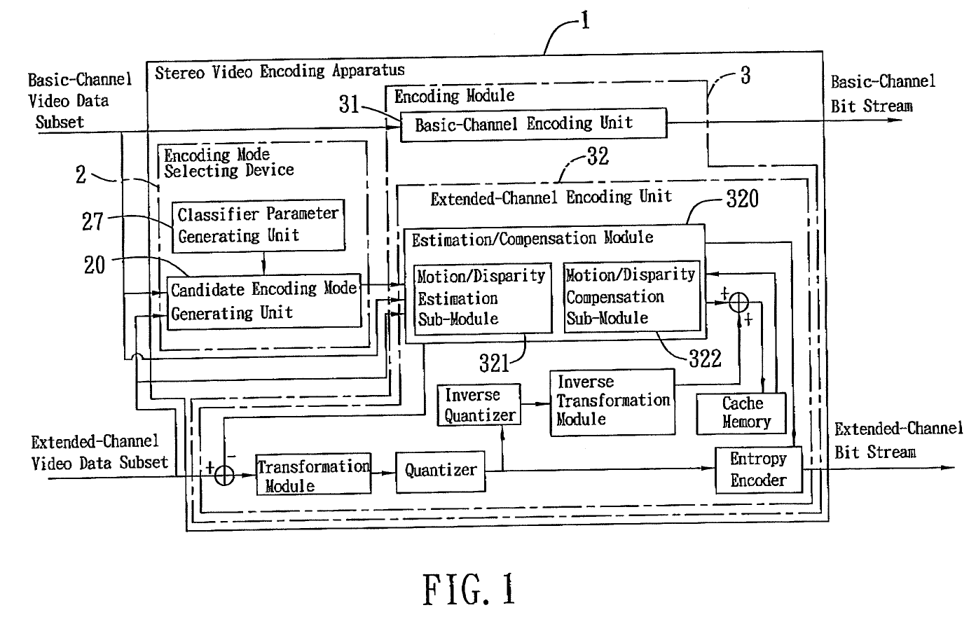

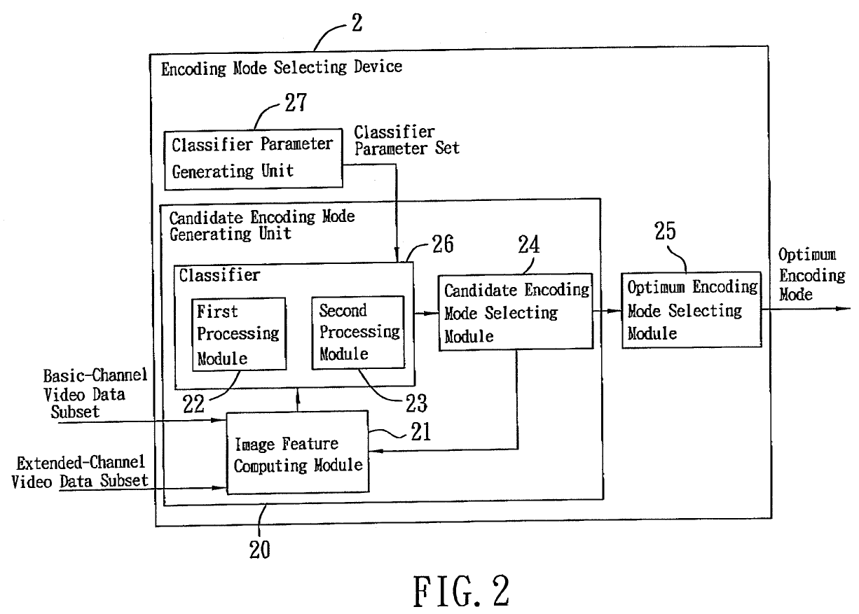

With reference to FIG. 1 and FIG. 2, a stereo video encoding apparatus 1 according to the preferred embodiment of the present invention is adapted for encoding a stereo video data set (or pair) that includes an extended-channel video data subset (e.g., a right-channel video data subset) and a basic-channel video data subset (e.g., a left-channel video data subset). Each of the extended-channel video data subset and the basic-channel video data subset includes a plurality of frames. Each of the frames includes a plurality of macroblocks. Each of the macroblocks includes a plurality of pixels.

The stereo video encoding apparatus 1 includes an encoding mode selecting device 2, and an encoding module 3. The encoding mode selecting device 2 determines an optimum encoding mode for each of the macroblocks of the extended-channel video data subset. The encoding module 3 is adapted for encoding the basic-channel video data subset so as to generate a basic-channel bit stream from the basic-channel video data subset, and is further adapted for generating an extended-channel bit stream from the extended-channel video data subset according to the optimum encoding modes as determined by the encoding mode selecting device 2.

The encoding mode selecting device 2 includes a candidate encoding mode generating unit 20 and an optimum encoding mode selecting module 25. The candidate encoding mode generating unit 20 includes an image feature computing module 21, a first processing module 22, and a candidate encoding mode selecting module 24.

The image feature computing module 21 is adapted for receiving the extended-channel video data subset, and generates, for each of the macroblocks of each of the frames of the extended-channel video data subset, a forward time difference image feature parameter set with reference to pixel values of the pixels of the corresponding one of the macroblocks of the corresponding one of the frames 51 of the extended-channel video data subset and the pixel values of the pixels of a corresponding one of the macroblocks of a corresponding preceding one of the frames 52 of the extended-channel video data subset.

The first processing module 22 is coupled electrically to the image feature computing module 21 for receiving the forward time difference image feature parameter set therefrom, and generates, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset.

The candidate encoding mode selecting module 24 is coupled electrically to the first processing module 22 for receiving the first output values therefrom, and selects for each of the macroblocks of the extended-channel video data subset, a first number (K₁) of candidate block partition sizes from the possible block partition sizes based on the first output values. The candidate encoding mode selecting module 24 generates, for each of the macroblocks of the extended-channel video data subset, a group of candidate encoding modes that includes combinations of the first number (K₁) of candidate block partition sizes for the corresponding one of the macroblocks of the extended-channel video data subset and at least a part of a plurality of predetermined possible block estimation directions.

The optimum encoding mode selecting module 25 is coupled electrically to the candidate encoding mode selecting module 24 for receiving the group of candidate encoding modes therefrom, and determines, for each of the macroblocks of the extended-channel video data subset, an optimum encoding mode from the group of candidate encoding modes for the corresponding one of the macroblocks of the extended-channel video data subset.

In this embodiment, since the stereo video encoding apparatus 1 utilizes the JMVM reference software that is based on a H.264/AVC-standard-like principle, the selection of the optimum encoding mode is performed by an extended-channel encoding unit 32 of the encoding module 3. In particular, the extended-channel encoding unit 32 includes an estimation/compensation module 320 including a motion/disparity estimation sub-module 321 and a motion/disparity compensation sub-module 322 that respectively perform, for each of the candidate encoding modes, motion/disparity estimation and motion/disparity compensation. For each of the macroblocks of the extended-channel video data subset, the optimum encoding mode is determined with reference to distortions between reconstructed images using each of the candidate encoding modes and the corresponding one of the macroblocks of the extended-channel video data subset.

The encoding module 3 is coupled electrically to the optimum encoding mode selecting module 25 for receiving the optimum encoding modes therefrom, is adapted for encoding the basic-channel video data subset so as to generate a basic-channel bit stream from the basic-channel video data subset, and is further adapted for generating an extended-channel bit stream from the extended-channel video data subset according to the optimum encoding modes received from the optimum encoding mode selecting module 25.

In this embodiment, the encoding module 3 includes a basic-channel encoding unit 31 and the extended-channel encoding unit 32. The basic-channel encoding unit 31 is adapted for encoding the basic-channel video data subset so as to generate the basic-channel bit stream from the basic-channel video data subset. The extended-channel encoding unit 32 is adapted for generating the extended-channel bit stream from the extended-channel video data subset according to the optimum encoding modes received from the optimum encoding mode selecting module 25.

It should be noted herein that the stereo video encoding apparatus 1 according to the preferred embodiment of this invention utilizes the JMVM reference software that is based on a H.264/AVC-standard-like principle. The feature of this invention mainly resides in the candidate encoding mode generating unit 20, and the functionalities and operations of the encoding unit 3 are readily appreciated by those skilled in the art. Therefore, further details of the encoding unit 3 are omitted herein for the sake of brevity.

It should also be noted herein that although the stereo video data set is encoded/compressed using a H.264/AVC=standard-like principle in the preferred embodiment, other currently available encoding standards, such as MPEG-2 and MPEG-4, can also be used for encoding/compressing the stereo video data set in other embodiments of the present invention. In other words, the present invention is not limited in the standard used for encoding/compressing the stereo video data.

In this embodiment, the image feature computing module 21 further generates, for each of the frames of the extended-channel video data subsets a forward time difference image (D_{t-h,t}), where “t” and “t−h” represent time indices. The forward time difference image (D_{t-h,t}) includes a plurality of pixels, each of which has a pixel value that is equal to an absolute difference value between the pixel value of a corresponding one of the pixels of the corresponding one of the frames 51 of the extended-channel video data subset and the pixel value of a corresponding one of the pixels of the corresponding preceding one of the frames 52 of the extended-channel video data subset. The image feature computing module 21 generates the forward time difference image feature parameter set with reference to the forward time difference image (D_{t-h,t}).

Furthermore, in this embodiment, the candidate encoding mode generating unit 20 further includes a second processing module 23. The image feature computing module 21 is further adapted for receiving the basic-channel video data subset, is coupled electrically to the candidate encoding mode selecting module 24 for receiving the first number (K₁) of candidate block partition sizes therefrom, and further generates, for each of a plurality of sub-blocks obtained by partitioning a corresponding one of the macroblocks of the extended-channel video data subset using the candidate block partition sizes selected for the corresponding one of the macroblocks, an estimation direction difference image feature parameter set with reference to the pixel values of the pixels of the corresponding one of the macroblocks of the corresponding one of the frames 51 of the extended-channel video data subset, the pixel values of the pixels of the corresponding one of the macroblocks of the corresponding preceding one of the frames 52 of the extended-channel video data subset, the pixel values of the pixels of a corresponding one of the macroblocks of a corresponding succeeding one of the frames 53 of the extended-channel video data subset, and the pixel values of the pixels in a corresponding area of a corresponding one of the frames 54 of the basic-channel video data subset.

The second processing module 23 is coupled electrically to the image feature computing module 21 for receiving the estimation direction difference image feature parameter set therefrom, and generates, for each of the sub-blocks obtained using the candidate block partition sizes, a plurality of second output values that respectively correspond to the plurality of predetermined possible block estimation directions with reference to the estimation direction difference image feature parameter set for the corresponding one of the sub-blocks.

The candidate encoding mode selecting module 24 is coupled electrically to the second processing module 23, and further selects, for each of the sub-blocks obtained using the candidate block partition sizes, a second number (K₂) of candidate block estimation directions from the predetermined possible block estimation directions according to the second output values.

The second numbers (K₂) of candidate block estimation directions selected for the sub-blocks of a corresponding one of the macroblocks form a third number of candidate block estimation directions for the corresponding one of the macroblocks.

The group of candidate encoding modes for each of the macroblocks of the extended-channel video data subset includes combinations of the first number (K₁) of candidate block partition sizes for the corresponding one of the macroblocks of the extended-channel video data subset and the third number of candidate block estimation directions for the corresponding one of the macroblocks of the extended-channel video data subset.

Moreover, in addition to the forward time difference image (D_{t-h,t}), the image feature computing module 21 further generates a backward time difference image (D_{t,t+k}) for each of the frames of the extended-channel video data subset, and a disparity estimation difference image (D_{t,t}) for each of the sub-blocks obtained using the candidate block partition sizes, where “t” and “t+k” represent time indices. The backward time difference image (D_{t,t+k}) includes a plurality of pixels, each of which has a pixel value that is equal to an absolute difference value between the pixel value of a corresponding one of the pixels of the corresponding one of the frames 51 of the extended-channel video data subset and the pixel value of a corresponding one of the pixels of the corresponding succeeding one of the frames 53 of the extended-channel video data subset. The disparity estimation difference image (D_{t,t}) includes a plurality of pixels, each of which has a pixel value that is equal to an absolute difference value between the pixel value of a corresponding one of the pixels of the corresponding one of the sub-blocks of the corresponding one of the frames 51 of the extended-channel video data subset and the pixel value of a corresponding one of the pixels in an area that corresponds to the sub-block of the corresponding one of the frames 54 of the basic-channel video data subset.

The estimation direction difference image feature parameter set is generated with reference to the forward time difference image (D_{t-h,t}), the backward time difference image (D_{t,t+k}), and the disparity estimation difference image (D_{t,t}).

In the preferred embodiment, the candidate encoding mode generating unit 20 further includes a classifier 26 that includes the first and second processing modules 22, 23. Preferably, the classifier 26 is implemented using a two-stage neural network, where a first-stage neural network is for implementing the first processing module 22, and a second-stage neural network is for implementing the second processing module 23. It should be noted herein that although the classifier 26 is implemented using the two-stage neural network in this embodiment, other currently available classifiers, such as support vector machine (SVM) classifiers, Bayesian classifiers, Fisher's classifiers, K-NN classifiers, etc., may also be used for the classifier 26 in other embodiments of the present invention. In addition, the classifier 26 is not limited to a two-stage implementation, as long as the classifier 26 supports all possible encoding modes for the particular application.

Furthermore, the encoding mode selecting device 2 further includes a classifier parameter generating unit 27 that generates a classifier parameter set, and that is coupled electrically to the classifier 26 for providing the classifier parameter set thereto. The classifier parameter set includes first and second classifier parameter subsets. The first processing unit 22 generates the first output values with reference to the forward time difference image feature parameter set and the first classifier parameter subset, and the second processing unit 23 generates the second output values with reference to the estimation direction difference image feature parameter set and the second classifier parameter subset.

It should be noted herein that the classifier parameter generating unit 27 is not an essential part of the encoding mode selecting device 2 according to the present invention. In other words, the classifier parameter set may be predetermined external of the encoding mode selecting device 2 in other embodiments of the present invention.

The stereo video encoding apparatus is further described with reference to a stereo video encoding method according to the preferred embodiment of the present invention. The stereo video encoding method is basically divisible into three procedures, namely, a preparation procedure, a mode selecting procedure, and a compressing procedure.

In the preparation procedure, the classifier parameter generating unit 27 generates the classifier parameter set. The classifier parameter generating unit 27 is a neural network that has a multi-layer feed-forward network structure.

For each of a plurality of training stereo video data sets, the classifier parameter generating unit 27 takes a training forward time difference image feature parameter set that corresponds to the training stereo video data set as a first input set, and defines a plurality of first output values that respectively correspond to the predetermined possible block partition sizes as a first desired output set. The classifier parameter generating unit 27 uses a plurality of randomly selected first weights respectively for a plurality of neurodes in the classifier parameter generating unit 27, and performs iteration to adjust the first weights until the classifier parameter generating unit 27 settles to a stable state. The resultant first weights form the first classifier parameter subset to be subsequently used by the first processing module 22.

For each of the training stereo video data sets, the classifier parameter generating unit 27 further takes a training estimation direction difference image feature parameter set that corresponds to the training stereo video data set as a second input set, and defines a plurality of second output values that respectively correspond to the predetermined possible block estimation directions as a second desired output set. The classifier parameter generating unit 27 uses a plurality of randomly selected second weights respectively for the neurodes in the classifier parameter generating unit 27, and performs iteration to adjust the second weights until the classifier parameter generating unit 27 settles to a stable state. The resultant second weights form the second classifier parameter subset to be subsequently used by the second processing module 23.

It should be noted herein that since the abovedescribed generation of the classifier parameter set uses techniques known to those skilled in the art, further details of the same are omitted herein for the sake of brevity. Furthermore, it should also be noted herein that since the feature of the present invention does not reside in the generation of the classifier parameter set, the same should not be construed to limit the scope of the present invention.

Subsequently, in the mode selecting procedure, an optimum encoding mode is generated for each of the macroblocks of each of the frames of the extended-channel video data subset.

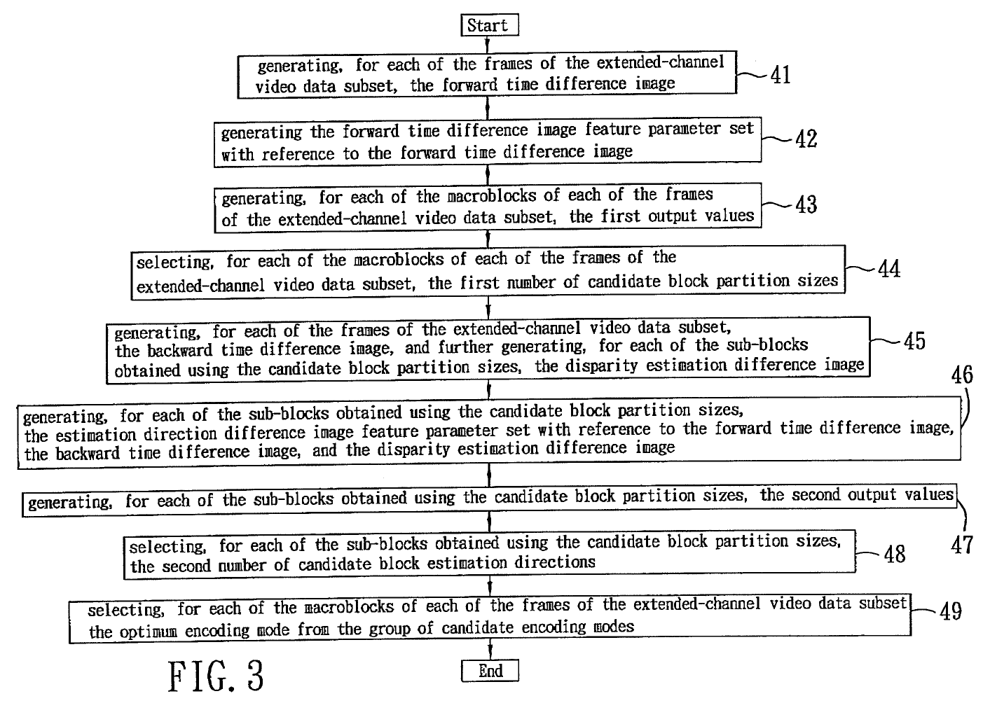

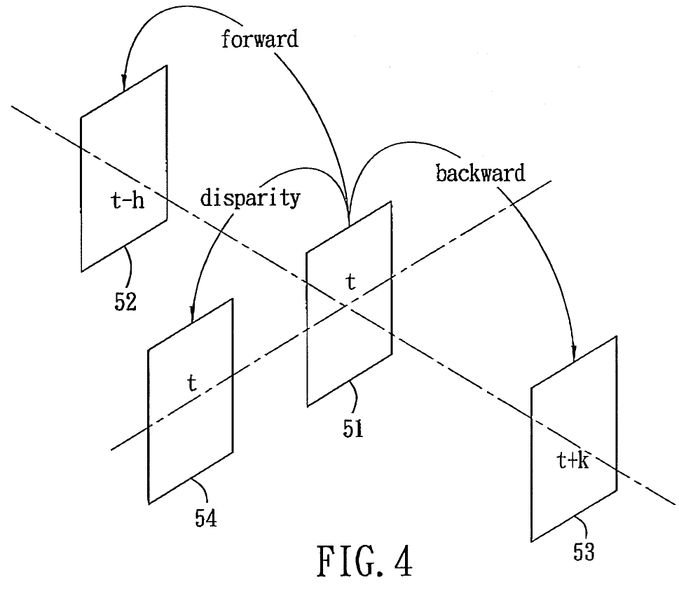

With reference to FIG. 2, FIG. 3 and FIG. 4, in step 41, the image feature computing module 21 generates, for each of the frames of the extended-channel video data subset, the forward time difference image (D_{t-h,t}) with reference to the pixel values of the pixels of the corresponding one of the frames 51 of the extended-channel video data subset, and the pixel values of the pixels of the corresponding preceding one of the frames 52 of the extended-channel video data subset.

In step 42, the image feature computing module 21 generates the forward time difference image feature parameter set with reference to the forward time difference image (D_{t-h,t}). In particular, the image feature computing module 21 first performs thresholding on the forward time difference image (D_{t-h,t}) so as to obtain a threshold image that separates foreground pixels from background pixels, where the foreground pixels are defined as the pixels in the forward time difference image (D_{t-h,t}) with pixel values that exceed a predetermined threshold and the background pixels are defined as the pixels in the forward time difference image (D_{t-h,t}) with pixel values that are below the predetermined threshold. Subsequently, the image feature computing module 21 generates the forward time difference image feature parameter set with reference to the forward time difference image (D_{t-h,t}) and the threshold image.

In this embodiment, the forward time difference image feature parameter set for each of the macroblocks of each of the frames of the extended-channel video data subset includes the following five parameters: (1) a mean of the pixel values of the pixels in an area of the forward time difference image (D_{t-h,t}) that corresponds to the macroblock, (2) a variance of the pixel values of the pixels in the area of the forward time difference image (D_{t-h,t}) that corresponds to the macroblock, (3) a ratio of a number of foreground pixels in the area of the forward time difference image (D_{t-h,t}) that corresponds to the macroblock to a number of pixels in the macroblock, (4) a difference between two means of the pixel values of the pixels in areas of the forward time difference image (D_{t-h,t}) that respectively correspond to two predetermined sub-blocks constituting the macroblock, and (5) a difference between two variances of the pixel values of the pixels in the areas of the forward time difference image (D_{t-h,t}) that respectively correspond to the two predetermined sub-blocks constituting the macroblock.

In this embodiment, the forward time difference image feature parameter set for each of the macroblocks of each of the frames of the extended-channel video data subset further includes the following two parameters: (6) a difference between two means of the pixel values of the pixels in areas of the forward time difference image (D_{t-h,}) that respectively correspond to another two predetermined sub-blocks constituting the macroblock, and (7) a difference between two variances of the pixel values of the pixels in the areas of the forward time difference image (D_{t-h,t}) that respectively correspond to the another two predetermined sub-blocks constituting the macroblock, i.e., the forward time difference image feature parameter set includes a total of seven parameters.

For example, in this embodiment, each of the macroblocks includes 16×16 pixels, each of the two predetermined sub-blocks constituting the macroblock includes 16×8 pixels, and each of the another two predetermined sub-blocks constituting the macroblock includes 8×16 pixels.

In step 43, the first processing module 22 receives the forward time difference image feature parameter set from the image feature computing module 21, and generates, for each of the macroblocks of each of the frames of the extended-channel video data subset, the first output values that respectively correspond to the predetermined possible block partition sizes with reference to the first classifier parameter subset obtained in the preparation procedure and the forward time difference image feature parameter set for the corresponding one of the macroblocks of the extended-channel video data subset.

In step 44, the candidate encoding mode selecting module 24 selects, for each of the macroblocks of each of the frames of the extended-channel video data subset, the first number (K₁) of candidate block partition sizes from the possible block partition sizes based on the first output values. Only the first number (K₁) of candidate block partition sizes will be used for subsequent determination of the optimum encoding mode, while the non-selected ones of the possible block partition sizes will not be used for subsequent determination of the optimum encoding mode. In this embodiment, the first number (K₁) of candidate block partition sizes are selected based on magnitude of the first output values, where the block partition sizes corresponding to the first number (K₁) of largest first output values are selected. As a result, computation time for determining the optimum encoding mode is reduced.

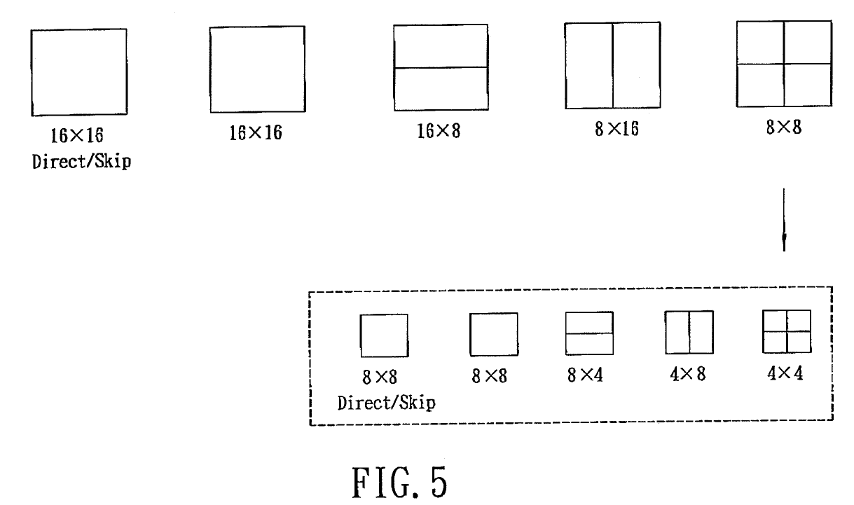

In this embodiment, there is a total of six possible block partition sizes, namely 16×16 Direct/Skip, 16×16 Inter, 16×8, 8×16, 8×8, and Intra Prediction. In the following description, each of the macroblocks includes 16×16 pixels, and each of the sub-blocks includes fewer than 16×16 pixels. For different block partition sizes, subsequent processing is different. For example, if either 16×16 Direct/Skip or Intra Prediction is chosen as one of the candidate block partition sizes, further motion vector estimation is not required, which would also save time. On the other hand, if 16×16 Inter, 16×8, or 8×16 is chosen as one of the candidate block partition sizes, subsequent motion vector estimation is required. Moreover, if 8×8 is chosen as one of the candidate block partition sizes, further partitioning of each of the 8×8 sub-blocks is required using 8×8 Direct/Skip, 8×8, 8×4, 4×8, and 4×4 predetermined partition sizes (as shown in FIG. 5).

In step 45, the image feature computing module 21 generates, for each of the frames of the extended-channel video data subset, the backward time difference image (D_{t,t+k}) with reference to the pixel values of the pixels of the corresponding one of the frames 51 of the extended-channel video data subset, and the pixel values of the pixels of the corresponding succeeding one of the frames 53 of the extended-channel video data subset, and further generates, for each of the sub-blocks obtained using the candidate block partition sizes, the disparity estimation difference image (D_{t,t}) with reference to the pixel values of the pixels of the corresponding one of the sub-blocks of the corresponding one of the frames 51 of the extended-channel video data subset and the pixel values of the pixels in the corresponding area of the corresponding one of the frames 54 of the basic-channel video data subset.

In this embodiment, the disparity estimation difference image (D_{t,t}) for each of the sub-blocks is generated in the following manner. First, the basic-channel video data subset is searched at several positions within a horizontal search window. For example, the basic-channel video data subset is searched at five positions within a horizontal search window having a pixel range of [−48,48]. The five positions respectively correspond to horizontal pixel search values of −48, −24, 0, 24 and 48. A region having a size identical to the corresponding one of the sub-blocks is defined for each of the positions. Next, a sum of absolute differences (SAD) is calculated between the pixel values of the pixels in the corresponding one of the sub-blocks of the corresponding one of the frames 51 of the extended-channel video data subset and the pixel values of the pixels in the region of the corresponding one of the frames 54 of the basic-channel video data subset corresponding to each of the horizontal pixel search values. Subsequently, the region resulting in the least sum of absolute differences is used to generate the disparity estimation difference image (D_{t,t}) for the corresponding one of the sub-blocks, where the disparity estimation difference image (D_{t,t}) includes a plurality of pixels, each of which has a pixel value that is equal to an absolute difference value between the pixel value of a corresponding one of the pixels of the corresponding one of the sub-blocks of the corresponding one of the frames 51 of the extended-channel video data subset and the pixel value of a corresponding one of the pixels of the corresponding one of the regions of the corresponding one of the frames 54 of the basic-channel video data subset.

In step 46, the image feature computing module 21 receives the candidate block partition sizes from the candidate encoding mode selecting module 24, and generates, for each of the sub-blocks obtained using the candidate block partition sizes, the estimation direction difference image feature parameter set with reference to the forward time difference image (D_{t-h,t}), the backward time difference image (D_{t,t+k}), and the disparity estimation difference image (D_{t,t}).

In particular, the estimation direction difference image feature parameter set includes the following six parameters: (1) a mean of the pixel values of the pixels in an area of the forward time difference image (D_{t-h,t}) that corresponds to the sub-block, (2) a variance of the pixel values of the pixels in the area of the forward time difference image (D_{t-h,t}) that corresponds to the sub-block, (3) a mean of the pixel values of the pixels in an area of the backward time difference image (D_{t,t+k}) that corresponds to the sub-block, (4) a variance of the pixel values of the pixels in the area of the backward time difference image (D_{t,t+k}) that corresponds to the sub-block, (5) a mean of the pixel values of the pixels in an area of the disparity estimation difference image (D_{t,t}) that corresponds to the sub-block, and (6) a variance of the pixel values of the pixels in the area of the disparity estimation difference image (D_{t,t}) that corresponds to the sub-block.

In step 47, the second processing module 23 receives the estimation direction difference image feature parameter set from the image feature computing module 21, and generates, for each of the sub-blocks obtained using the candidate block partition sizes, the second output values that respectively correspond to the predetermined possible block estimation directions with reference to the second classifier parameter subset obtained in the preparation procedure and the estimation direction difference image feature parameter set for the corresponding one of the sub-blocks.

In step 48, the candidate encoding mode selecting module 24 selects, for each of the sub-blocks obtained using the candidate block partition sizes, the second number (K₂) of candidate block estimation directions from the possible block estimation directions based on the second output values. Only the second number (K₂) of candidate block estimation directions will be used for subsequent determination of the optimum encoding mode, while the non-selected ones of the possible block estimation directions will not be used for subsequent determination of the optimum encoding mode. As a result, computation time for determining the optimum encoding mode is further reduced.

There are two ways for selecting the second number (K₂)of candidate block estimation directions. In a first implementation, the second number (K₂) is a predetermined number, e.g., two, and the predetermined possible block estimation directions corresponding to two second output values that demonstrate better performance are selected as the candidate block estimation directions. In this embodiment, the second output values are defined to have better performance when magnitudes thereof are greater. In this case, the second number (K₂) is a fixed number for all of the sub-blocks. In a second implementation, a set of predetermined threshold conditions, which may be obtained empirically, are used for comparison with the second output values so as to determine whether the corresponding ones of the predetermined possible block estimation directions are to be selected as the candidate block estimation directions. In this case, the second number (K₂) may vary among the sub-blocks, depending on the second output values obtained for the sub-blocks.

As shown in FIG. 1, FIG. 2 and FIG. 4, in this embodiment, the first implementation is used for selecting the second number (K₂) of candidate block estimation directions. In addition, the predetermined possible block estimation directions include a forward direction (F), a backward direction (B), and a disparity direction (D). It should be noted herein that the JMVM reference software allows five different combinations of prediction sources for motion/disparity estimation, including a single prediction source in the forward direction (F), a single prediction source in the backward direction (B), a single prediction source in the disparity direction (D), a combination of two prediction sources respectively in the forward and backward direction (F, B), and a combination of two prediction sources respectively in the disparity and backward directions (D, B). Therefore, assuming that the second number (K₂) is two, i.e., K₂=2, and that the candidate block estimation directions selected for a particular sub-block include the forward and disparity directions (F, D), then for applications using the JMVM reference software, two sets of prediction sources are used in the computations for determining the optimum encoding mode for that particular sub-block, where one set includes a single prediction source in the forward direction (F) and the other set includes a single prediction source in the disparity direction (D). In another instance where the second number (K₂) is two, i.e., K₂=2, and the candidate block estimation directions selected for a particular sub-block include the forward and backward directions (F, B), then for applications using the JMVM reference software, three sets of prediction sources are used in the computations for determining the optimum encoding mode for that particular sub-block, where one set includes a single prediction source in the forward direction (F), one set includes a single prediction source in the backward direction (B), and one set includes a combination of two prediction sources respectively in the forward and backward directions (F, B).

The second numbers (K₂) of candidate block estimation directions selected for the sub-blocks of a corresponding one of the macroblocks form a third number of candidate block estimation directions for the corresponding one of the macroblocks. The group of candidate encoding modes for each of the macroblocks of the extended-channel video data subset includes combinations of the first number of candidate block partition sizes for the corresponding one of the macroblocks of the extended-channel video data subset and the third number of candidate block estimation directions for the corresponding one of the macroblocks of the extended-channel video data subset.

In step 49, for each of the macroblocks of each of the frames of the extended-channel video data subset, the optimum encoding mode is selected from the group of candidate encoding modes. In this embodiment, the optimum encoding mode is selected by using the rate-distortion optimization (RDO) technique as with the H.264/AVC standard. Since the technical feature of the present invention does not reside in this aspect, further details of the same are omitted herein for the sake of brevity.

Finally, in the compressing procedure, the basic-channel video data subset is encoded so as to generate the basic-channel bit stream from the basic-channel video data subset, and the extended-channel bit stream is generated from the extended-channel video data subset according to the optimum encoding modes selected for the macroblocks of the frames thereof.

It should be noted herein that since the compressing procedure may be carried out using conventionally known methods, and since the feature of the present invention does not reside therein, further details of the same are omitted herein for the sake of brevity.

It should be further noted herein that the time-saving effect attributed to selecting the first number (K₁) of candidate block partition sizes from the possible block partition sizes is greater than that attributed to selecting the second number (K₂) of candidate block estimation directions from the possible block estimation directions. Therefore, steps 45 to 48 may be omitted in other embodiments of the present invention, where the group of candidate encoding modes for the corresponding one of the macroblocks of the extended-channel video data subset is formed by the combinations of the first number (K₁) of candidate block partition sizes for the corresponding macroblock of the extended-channel video data subset and at least a part of the predetermined possible block estimation directions.

In sum, the method for generating a group of candidate encoding modes according to the present invention eliminates, in an early stage, those of a plurality of predetermined possible encoding modes that are not suitable for encoding an extended-channel video data subset of a stereo video data set, so as to greatly reduce the computation time required for encoding the same.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating a group of candidate encoding modes, from which an optimum encoding mode is to be selected for subsequent encoding of an extended-channel video data subset of a stereo video data set with reference to a basic-channel video data subset of the stereo video data set, each of the extended-channel video data subset and the basic-channel video data subset including a plurality of frames, each of the frames including a plurality of macroblocks, each of the macroblocks including a plurality of pixels, the method comprising the steps of:
(A) generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
(B) generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset; and
(C) selecting, for each of the macroblocks of the extended-channel video data subset, a first number of candidate block partition sizes from the possible block partition sizes based on the first output values; and
wherein the group of candidate encoding modes for each of the macroblocks of the extended-channel video data subset includes combinations of the first number of candidate block partition sizes for the corresponding one of the macroblocks of the frames of the extended-channel video data subset and at least a part of a plurality of predetermined possible block estimation directions.

2. The method as claimed in claim 1, further comprising the step of generating, for each of the frames of the extended-channel video data subset, a forward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding preceding one of the frames of the extended-channel video data subset; and
wherein the forward time difference image feature parameter set is generated with reference to the forward time difference image.

3. The method as claimed in claim 2, wherein the forward time difference image feature parameter set for each of the macroblocks of each of the frames of the extended-channel video data subset includes a mean of the pixel values of the pixels in an area of the forward time difference image that corresponds to the macroblock, a variance of the pixel values of the pixels in the area of the forward time difference image that corresponds to the macroblock, a ratio of a number of foreground pixels in the area of the forward time difference image that corresponds to the macroblock to a number of pixels in the macroblock, a difference between two means of the pixel values of the pixels in areas of the forward time difference image that respectively correspond to two predetermined sub-blocks constituting the macroblock, and a difference between two variances of the pixel values of the pixels in the areas of the forward time difference image that respectively correspond to the two predetermined sub-blocks constituting the macroblock.

4. The method as claimed in claim 1, further comprising the steps of:
generating, for each of a plurality of sub-blocks obtained by partitioning a corresponding one of the macroblocks of the extended-channel video data subset using the candidate block partition sizes selected for the corresponding one of the macroblocks, an estimation direction difference image feature parameter set with reference to the pixel values of the pixels of the corresponding one of the macroblocks of the corresponding one of the frames of the extended-channel video data subset, the pixel values of the pixels of the corresponding one of the macroblocks of the corresponding preceding one of the frames of the extended-channel video data subset, the pixel values of the pixels of a corresponding one of the macroblocks of a corresponding succeeding one of the frames of the extended-channel video data subset, and the pixel values of the pixels in a corresponding area of a corresponding one of the frames of the basic-channel video data subset;
generating, for each of the sub-blocks obtained using the candidate block partition sizes, a plurality of second output values that respectively correspond to the plurality of predetermined possible block estimation directions with reference to the estimation direction difference image feature parameter set for the corresponding one of the sub-blocks; and
selecting, for each of the sub-blocks obtained using the candidate block partition sizes, a second number of candidate block estimation directions from the predetermined possible block estimation directions according to the second output values; and
wherein the second numbers of candidate block estimation directions selected for the sub-blocks of a corresponding one of the macroblocks form a third number of candidate block estimation directions for the corresponding one of the macroblocks; and
wherein the group of candidate encoding modes for each of the macroblocks of the extended-channel video data subset includes combinations of the first number of candidate block partition sizes for the corresponding one of the macroblocks of the extended-channel video data subset and the third number of candidate block estimation directions for the corresponding one of the macroblocks of the extended-channel video data subset.

5. The method as claimed in claim 4, further comprising the steps of:
generating, for each of the frames of the extended-channel video data subset, a forward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding preceding one of the frames of the extended-channel video data subset;
generating, for each of the frames of the extended-channel video data subset, a backward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding succeeding one of the frames of the extended-channel video data subset; and
generating, for each of the sub-blocks obtained using the candidate block partition sizes, a disparity estimation difference image that includes a plurality of pixels, each of which has a pixel value that is equal to an absolute difference value between the pixel value of a corresponding one of the pixels of the corresponding one of the sub-blocks of the corresponding one of the frames of the extended-channel video data subset and the pixel value of a corresponding one of the pixels in an area that corresponds to the sub-block of the corresponding one of the frames of the basic-channel video data subset; and
wherein the forward time difference image feature parameter set is generated with reference to the forward time difference image, and the estimation direction difference image feature parameter set is generated with reference to the forward time difference image, the backward time difference image, and the disparity estimation difference image.

6. The method as claimed in claim 5, wherein the estimation direction difference image feature parameter set includes a mean of the pixel values of the pixels in an area of the forward time difference image that corresponds to the sub-block, a variance of the pixel values of the pixels in the area of the forward time difference image that corresponds to the sub-block, a mean of the pixel values of the pixels in an area of the backward time difference image that corresponds to the sub-block, a variance of the pixel values of the pixels in the area of the backward time difference image that corresponds to the sub-block, a mean of the pixel values of the pixels in an area of the disparity estimation difference image that corresponds to the sub-block, and a variance of the pixel values of the pixels in the area of the disparity estimation difference image that corresponds to the sub-block.

7. A method for selecting an optimum encoding mode for subsequent encoding of an extended-channel video data subset of a stereo video data set with reference to a basic-channel video data subset of the stereo video data set, each of the extended-channel video data subset and the basic-channel video data subset including a plurality of frames, each of the frames including a plurality of macroblocks, each of the macroblocks including a plurality of pixels, the method comprising the steps of:
(A) generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
(B) generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset;
(C) selecting, for each of the macroblocks of each of the frames of the extended-channel video data subset, a first number of candidate block partition sizes from the possible block partition sizes based on the first output values, combinations of the first number of candidate block partition sizes for each of the macroblocks of the extended-channel video data subset and at least a part of a plurality of predetermined possible block estimation directions forming a group of candidate encoding modes for the corresponding one of the macroblocks of the extended-channel video data subset; and
(D) selecting, for each of the macroblocks of the extended-channel video data subset, the optimum encoding mode from the group of candidate encoding modes

8. A method for encoding an extended-channel video data subset of a stereo video data set with reference to a basic-channel video data subset of the stereo video data set, each of the extended-channel video data subset and the basic-channel video data subset including a plurality of frames, each of the frames including a plurality of macroblocks, each of the macroblocks including a plurality of pixels, the method comprising the steps of:
(A) generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
(B) generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset;
(C) selecting, for each of the macroblocks of each of the frames of the extended-channel video data subset, a first number of candidate block partition sizes from the possible block partition sizes based on the first output values, combinations of the first number of candidate block partition sizes for each of the macroblocks of the extended-channel video data subset and at least a part of a plurality of predetermined possible block estimation directions forming a group of candidate encoding modes for the corresponding one of the macroblocks of the extended-channel video data subset;
(D) selecting, for each of the macroblocks of each of the frames of the extended-channel video data subset, the optimum encoding mode from the group of candidate encoding modes; and
(E) encoding the extended-channel video data subset according to the optimum encoding modes selected for the macroblocks of the frames thereof.

9. A candidate encoding mode generating unit for generating a group of candidate encoding modes, from which an optimum encoding mode is to be selected for subsequent encoding of an extended-channel video data subset of a stereo video data set with reference to a basic-channel video data subset of the stereo video data set, each of the extended-channel video data subset and the basic-channel video data subset including a plurality of frames, each of the frames including a plurality of macroblocks, each of the macroblocks including a plurality of pixels, said candidate encoding mode generating unit comprising:
an image feature computing module adapted for receiving the extended-channel video data subset, and generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
a first processing module coupled electrically to said image feature computing module for receiving the forward time difference image feature parameter set therefrom, and generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset; and
a candidate encoding mode selecting module coupled electrically to said first processing module for receiving the first output values therefrom, and selecting, for each of the macroblocks of the extended-channel video data subset, a first number of candidate block partition sizes from the possible block partition sizes based on the first output values;
wherein said candidate encoding mode selecting module generates, for each of the macroblocks of the extended-channel video data subset, the group of candidate encoding modes that includes combinations of the first number of candidate block partition sizes for the corresponding one of the macroblocks of the extended-channel video data subset and at least a part of a plurality of predetermined possible block estimation directions.

10. The candidate encoding mode generating unit as claimed in claim 9, wherein said image feature computing module further generates, for each of the frames of the extended-channel video data subset, a forward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding preceding one of the frames of the extended-channel video data subset; and
said image feature computing module generates the forward time difference image feature parameter set with reference to the forward time difference image.

11. The candidate encoding mode generating unit as claimed in claim 10, wherein the forward time difference image feature parameter set for each of the macroblocks of each of the frames of the extended-channel video data subset includes a mean of the pixel values of the pixels in an area of the forward time difference image that corresponds to the macroblock, a variance of the pixel values of the pixels in the area of the forward time difference image that corresponds to the macroblock, a ratio of a number of foreground pixels in the area of the forward time difference image that corresponds to the macroblock to a number of pixels in the macroblock, a difference between two means of the pixel values of the pixels in areas of the forward time difference image that respectively correspond to two predetermined sub-blocks constituting the macroblock, and a difference between two variances of the pixel values of the pixels in the areas of the forward time difference image that respectively correspond to the two predetermined sub-blocks constituting the macroblock.

12. The candidate encoding mode generating unit as claimed in claim 9, wherein said first processing module is a neural network.

13. The candidate encoding mode generating unit as claimed in claim 9, wherein:
said image feature computing module is further adapted for receiving the basic-channel video data subset, is coupled electrically to said candidate encoding mode selecting module for receiving the first number of candidate block partition sizes therefrom, and further generates, for each of a plurality of sub-blocks obtained by partitioning a corresponding one of the macroblocks of the extended-channel video data subset using the candidate block partition sizes selected for the corresponding one of the macroblocks, an estimation direction difference image feature parameter set with reference to the pixel values of the pixels of the corresponding one of the macroblocks of the corresponding one of the frames of the extended-channel video data subset, the pixel values of the pixels of the corresponding one of the macroblocks of the corresponding preceding one of the frames of the extended-channel video data subset, the pixel values of the pixels of a corresponding one of the macroblocks of a corresponding succeeding one of the frames of the extended-channel video data subset, and the pixel values of the pixels in a corresponding area of a corresponding one of the frames of the basic-channel video data subset;
said candidate encoding mode generating unit further comprising a second processing module coupled electrically to said image feature computing module for receiving the estimation direction difference image feature parameter set therefrom, and generating, for each of the sub-blocks obtained using the candidate block partition sizes, a plurality of second output values that respectively correspond to the plurality of predetermined possible block estimation directions with reference to the estimation direction difference image feature parameter set for the corresponding one of the sub-blocks;
said candidate encoding mode selecting module being coupled electrically to said second processing module, and further selecting, for each of the sub-blocks obtained using the candidate block partition sizes, a second number of candidate block estimation directions from the predetermined possible block estimation directions according to the second output values;
the second numbers of candidate block estimation directions selected for the sub-blocks of a corresponding one of the macroblocks forming a third number of candidate block estimation directions for the corresponding one of the macroblocks; and
the group of candidate encoding modes for each of the macroblocks of the extended-channel video data subset including combinations of the first number of candidate block partition sizes for the corresponding one of the macroblocks of the extended-channel video data subset and the third number of candidate block estimation directions for the corresponding one of the macroblocks of the extended-channel video data subset.

14. The candidate encoding mode generating unit as claimed in claim 13, wherein:
said image feature computing module further generates, for each of the frames of the extended-channel video data subset, a forward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding preceding one of the frames of the extended-channel video data subset;
said image feature computing module further generates, for each of the frames of the extended-channel video data subset, a backward time difference image that includes a plurality of pixels, each of which has a pixel value that is equal to an absolute difference value between the pixel value of a corresponding one of the pixels of the corresponding one of the frames of the extended-channel video data subset and the pixel value of a corresponding one of the pixels of the corresponding succeeding one of the frames of the extended-channel video data subset;
said image feature computing module further generates, for each of the sub-blocks obtained using the candidate block partition sizes, a disparity estimation difference image that includes a plurality of pixels, each of which has a pixel value that is equal to an absolute difference value between the pixel value of a corresponding one of the pixels of the corresponding one of the sub-blocks of the corresponding one of the frames of the extended-channel video data subset and the pixel value of a corresponding one of the pixels in an area that corresponds to the sub-block of the corresponding one of the frames of the basic-channel video data subset; and
the forward time difference image feature parameter set is generated with reference to the forward time difference image, and the estimation direction difference image feature parameter set is generated with reference to the forward time difference image, the backward time difference image, and the disparity estimation difference image.

15. The candidate encoding mode generating unit as claimed in claim 14, wherein the estimation direction difference image feature parameter set includes a mean of the pixel values of the pixels in an area of the forward time difference image that corresponds to the sub-block, a variance of the pixel values of the pixels in the area of the forward time difference image that corresponds to the sub-block, a mean of the pixel values of the pixels in an area of the backward time difference image that corresponds to the sub-block, a variance of the pixel values of the pixels in the area of the backward time difference image that corresponds to the sub-block, a mean of the pixel values of the pixels in an area of the disparity estimation difference image that corresponds to the sub-block, and a variance of the pixel values of the pixels in the area of the disparity estimation difference image that corresponds to the sub-block.

16. The candidate encoding mode generating unit as claimed in claim 13, wherein said second processing module is a neural network.

17. The candidate encoding mode generating unit as claimed in claim 13, wherein said first and second processing modules are implemented using a classifier.

18. An encoding mode selecting device for an extended-channel video data subset of a stereo video data set, the stereo video data set further including a basic-channel video data subset, each of the extended-channel video data subset and the basic-channel video data subset including a plurality of frames, each of the frames including a plurality of macroblocks, each of the macroblocks including a plurality of pixels, said encoding mode selecting device comprising:
an image feature computing module adapted for receiving the extended-channel video data subset, and generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
a first processing module coupled electrically to said image feature computing module for receiving the forward time difference image feature parameter set therefrom, and generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset;
a candidate encoding mode selecting module coupled electrically to said first processing module for receiving the first output values therefrom, and selecting, for each of the macroblocks of the extended-channel video data subset, a first number of candidate block partition sizes from the possible block partition sizes based on the first output values, said candidate encoding mode selecting module generating, for each of the macroblocks of the extended-channel video data subset, a group of candidate encoding modes that includes combinations of the first number of candidate block partition sizes for the corresponding one of the macroblocks of the extended-channel video data subset and at least a part of a plurality of predetermined possible block estimation directions; and
an optimum encoding mode selecting module coupled electrically to said candidate encoding mode selecting module for receiving the group of candidate encoding modes therefrom, and determining, for each of the macroblocks of the extended-channel video data subset, an optimum encoding mode from the group of candidate encoding modes for the corresponding one of the macroblocks of the extended-channel video data subset.

19. A stereo video encoding apparatus for encoding a stereo video data set that includes an extended-channel video data subset and a basic-channel video data subset, each of the extended-channel video data subset and the basic-channel video data subset including a plurality of frames, each of the frames including a plurality of macroblocks, each of the macroblocks including a plurality of pixels, said stereo video encoding apparatus comprising:
an image feature computing module adapted for receiving the extended-channel video data subset, and generating, for each of the macroblocks of each of the frames of the extended-channel video data subset, a forward time difference image feature parameter set with reference to pixel values of the pixels of the corresponding one of the macroblocks of the corresponding one of the frames of the extended-channel video data subset and the pixel values of the pixels of a corresponding one of the macroblocks of a corresponding preceding one of the frames of the extended-channel video data subset;
a first processing module coupled electrically to said image feature computing module for receiving the forward time difference image feature parameter set therefrom, and generating, for each of the macroblocks of each of the frames of the extended-channel video data subset, a plurality of first output values that respectively correspond to a plurality of predetermined possible block partition sizes with reference to the forward time difference image feature parameter set for the corresponding one of the macroblocks of the extended-channel video data subset;
a candidate encoding mode selecting module coupled electrically to said first processing module for receiving the first output values therefrom, and selecting, for each of the macroblocks of the extended-channel video data subset, a first number of candidate block partition sizes from the possible block partition sizes based on the first output values, said candidate encoding mode selecting module generating, for each of the macroblocks of the extended-channel video data subset, a group of candidate encoding modes that includes combinations of the first number of candidate block partition sizes for the corresponding one of the macroblocks of the extended-channel video data subset and at least a part of a plurality of predetermined possible block estimation directions;
an optimum encoding mode selecting module coupled electrically to said candidate encoding mode selecting module for receiving the group of candidate encoding modes therefrom, and determining, for each of the macroblocks of the extended-channel video data subsets an optimum encoding mode from the group of candidate encoding modes for the corresponding one of the macroblocks of the extended-channel video data subset; and
an encoding module coupled electrically to said optimum encoding mode selecting module for receiving the optimum encoding modes therefrom, adapted for encoding the basic-channel video data subset so as to generate a basic-channel bit stream from the basic-channel video data subset, and further adapted for generating an extended-channel bit stream from the extended-channel video data subset according to the optimum encoding modes received from said optimum encoding mode selecting module.
